(19) United States
(12) Patent Application Publication
(10) Pub. No.: US 2024/0365772 A1
(43) Pub. Date: Nov. 7, 2024

(54) MOTION SIMULATING DECOY

(71) Applicants: Matt Moss, Memphis, TN (US); Michael Paloian, Lloyd Harbor, NY (US)

(72) Inventors: Matt Moss, Memphis, TN (US); Michael Paloian, Lloyd Harbor, NY (US)

(73) Assignee: Matt Moss, Memphis, TN (US)

(21) Appl. No.: 18/654,609

(22) Filed: May 3, 2024

Related U.S. Application Data
(60) Provisional application No. 63/545,343, filed on Oct. 23, 2023.
(60) Provisional application No. 63/463,679, filed on May 3, 2023.

(51) Int. Cl. A01M 31/06

(52) U.S. Cl. CPC A01M 31/06

(57) ABSTRACT

A decoy comprises a moveable member moveably affixed to a body where the moveable member is moveable relative to the body between a first position and a second position. The moveable member has a first region and a second region. The first region has a first visual indicia, and the second region has a second visual indicia. The first visual indicia being at least partially within the body in the first position. The first visual indicia being partially outside the body in the second position.

### FIELD

The disclosure relates to the field of decoys. More particularly, the disclosure relates to decoys useful for attracting animals. Specific examples of decoys and decoy systems are provided.

### BACKGROUND

Decoys have been used for many years as a tool to attract game animals, such as deer, geese, ducks, elk, and turkeys. These decoys typically mimic the appearance and behavior of real animals, thus drawing the attention of the target species and encouraging them to approach a hunting location.

Conventional decoys have several limitations. For example, many existing decoys lack the realism and mimicry of natural animal behavior necessary to attract game animals effectively. Use of conventional decoys, as a result, may not provide maximum opportunity for hunters.

A need exists, therefore, for improved decoys and decoy systems.

### BRIEF SUMMARY OF SELECTED EXAMPLES

Various example decoys are described.

An example decoy comprises a body and a movable member having a first surface with a first region and a second region separate from the first region; a first visual indicia disposed on the first region and a second visual indicia being different from the first visual indicia and disposed on the second region, the first visual indicia being at least partially within the body when the movable member is in a first position and at least partially outside the body when the movable member is in a second position; the second visual indicia being at least partially within the body when the movable member is in the second position and at least partially within the body when the movable member is in the first position.

Another example decoy comprises a body and a moveable member having a first surface with a first region and a second region separate from the first region; a first visual indicia disposed on the first region and a second visual indicia being different from the first visual indicia and disposed on the second region, the first visual indicia being at least partially within the body when the moveable member is in a first position and at least partially outside the body when the moveable member is in a second position; the second visual indicia being at least partially within the body when the moveable member is in the second position and at least partially within the body when the moveable member is in the first position; and a motor connected to the moveable member, the motor being adapted to move the moveable member from the first position to the second position.

Another example decoy comprises a body, having a head portion connected to a body portion that is connected to a tail portion, and a moveable disk having a first surface with a first region and a second region separate from the first region; a first visual indicia disposed on the first region and a second visual indicia being different from the first visual indicia and disposed on the second region, the first visual indicia being at least partially within the tail portion of the body when the moveable disk is in a first position and at least partially outside the body when the moveable disk is in a second position; the second visual indicia being at least partially within the tail portion of the body when the moveable disk is in the second position and at least partially within the tail portion of the body when the moveable disk is in the first position; and a motor connected to the moveable disk, the motor adapted to move the moveable disk from the first position to the second position.

Another example decoy comprises a tubular member partially disposed in a body. The tubular member having a proximal portion and a distal portion. The distal portion extending from a bottom surface of the decoy. The proximal portion protruding from a top surface of the decoy. A fan disposed within the tubular member.

Another example duck decoy comprises a body having a head portion connected to a body portion that is connected to a tail portion. A tubular member partially disposed in the body, the tubular member having a proximal portion and a distal portion. The distal portion extending from a bottom surface of the decoy. The proximal portion protruding from a top surface of the decoy. A fan disposed within the tubular member. A moveable disk moveably affixed and at least partially disposed in the tail portion of the body. The moveable disk moveable relative to the body between a first position and a second position. The moveable disk having a first surface with a first region and a second region separate from the first region. The first region having a first visual indicia, the second region having a second visual indicia. The first visual indicia being different than the second visual indicia. The first visual indicia is at least partially within the body in the first position. The first visual indicia is partially outside the body in the second position. A first motor connected to the moveable disk. The first motor being adapted to move the moveable disk from the first position to the second position. A second motor connected to the fan, the fan being configured to draw in air from an external environment surrounding a proximal end of the tubular member and expel air from a distal end of the tubular member.

Various example decoy systems are described.

An example decoy system comprises a remote control in operative communication with at least one decoy, the at least one motion decoy comprising a motor; a body, having a head portion connected to a body portion that is connected to a tail portion, and a moveable member having a first surface with a first region and a second region separate from the first region; a first visual indicia disposed on the first region and a second visual indicia being different from the first visual indicia and disposed on the second region, the first visual indicia being at least partially within the tail portion of the body when the moveable member is in a first position and at least partially outside the body when the moveable member is in a second position; the second visual indicia being at least partially within the tail portion of the body when the moveable member is in the second position and at least partially within the tail portion of the body when the moveable member is in the first position; and a motor connected to the moveable member, the motor adapted to move the moveable member from the first position to the second position.

Another example decoy system comprises a remote control in operative communication with a motor. A body having a head portion connected to a body portion that is connected to a tail portion. A tubular member partially disposed in the body, the tubular member having a proximal portion and a distal portion. The distal portion extending from a bottom surface of the decoy. The proximal portion protruding from a top surface of the decoy. A fan disposed within the tubular member, the fan being configured to draw in air from an external environment surrounding a proximal end of the tubular member and expel air from a distal end of the tubular member.

Additional understanding of the inventive decoys and decoy systems can be obtained by reviewing the detailed description of selected examples, below, and the referenced drawings.

### DESCRIPTION OF FIGURES

FIG. 1 is a side view of a first example decoy with a movable member in a first position.

FIG. 2 is a side view of the first example decoy with the movable member in a second position.

FIG. 3 is a top view of the movable member of the first example decoy.

FIG. 3a is a side view of an example moveable member of the first example decoy.

FIG. 3b is a side view of an example moveable member of the first example decoy.

FIG. 3c is a side view of an example moveable member of the first example decoy.

FIG. 4 is a perspective view of a second example decoy with a movable member in a first position.

FIG. 5 is a perspective view of the second example decoy with the movable member in a second position.

FIG. 6 is a side view of the movable member of the second example decoy.

FIG. 6a is a side view of an example moveable member of the second example decoy.

FIG. 6b is a side view of an example moveable member of the second example decoy.

FIG. 6c is a side view of an example moveable member of the second example decoy.

FIG. 7 is a side view of a third example decoy with a moveable member in a first position.

FIG. 8 is a side view of the third example decoy with the moveable member in a second position.

FIG. 9 is a top view of the moveable member of the third example decoy.

FIG. 9a is a side view of an example moveable member of the third example decoy.

FIG. 10 is a side view of a fourth example decoy.

FIG. 11 is a side view of the fourth example decoy with a top portion removed.

FIG. 12 is a top view of the fourth example decoy.

FIG. 13 is a schematic illustration of an example decoy system having three decoys and a remote control operably connected with the three decoys.

FIG. 14 is a side view of a fifth example decoy with a moveable member and a tubular member.

FIG. 15 is a side view of a sixth example decoy with a tubular member.

FIG. 16 is schematic illustration of an example decoy system having three decoys and a remote control operably connected with the three decoys.

FIG. 17 is a top view of a first example detachable moveable member attached to a decoy.

FIG. 18 is a top view of the first example detachable moveable member disposed in a housing that is attached to a decoy.

FIG. 19 is a partial sectional view of a second example detachable moveable member.

FIG. 20 is a top view of a third example detachable moveable member.

FIG. 21 is a perspective view of a fourth example detachable moveable member in a housing that is attached to a decoy.

FIG. 22 is a side view of the fourth example detachable moveable member in the housing that is attached to the decoy.

FIG. 23 is a partial perspective view of a fifth example detachable moveable member in a housing.

### DETAILED DESCRIPTION OF SELECTED EXAMPLES

The following detailed description and the appended drawings describe and illustrate various example decoys and decoy systems. The description and illustration of these examples enable one skilled in the art to make and use examples of decoys and decoy systems. They do not limit the scope of the claims in any manner.

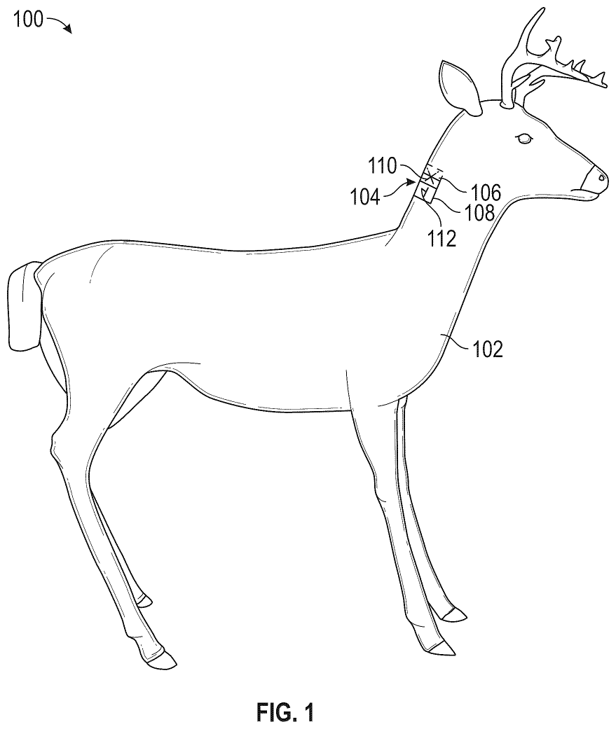

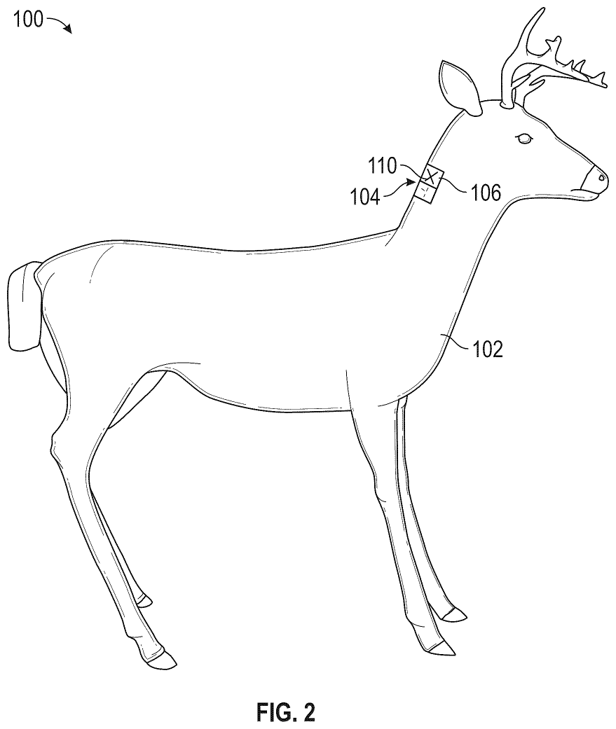

Each of FIGS. 1 and 2 illustrates a first example decoy 100. The decoy 100 has a body 102 and a movable member 104. In the illustrated example, the decoy 100 is in the shape of a deer; however, the decoy 100 can be any type of animal including, but not limited to, a bear, elk, moose, caribou, wild boar, bison, mountain goat, turkey, pheasant, grouse, quail, duck, goose, rabbit, squirrel, coyote, alligator, raccoon, or the like.

The movable member 104 is movable relative to the body 102 and is attached to, disposed within, or otherwise associated with the body 102 such that the movable member 104 can be moved relative to the body 102 to alternately permit and prevent visualization of the first 110 and second indicia 112 on a surface 104a of the movable member 104. The moveable member 104 can be movably affixed to the body 102 in any desired manner, so long as the moveable member 104 is moveable relative to the body 102 between a first position, as shown in FIG. 1, and a second position, as shown in FIG. 2. In the illustrated example, the moveable member 104 is moved from the first position to the second position by wind. However, the moveable member 104 can be moved by any means such as, but not limited to, an electric motor, combustion engine, water, gravity, or the like.

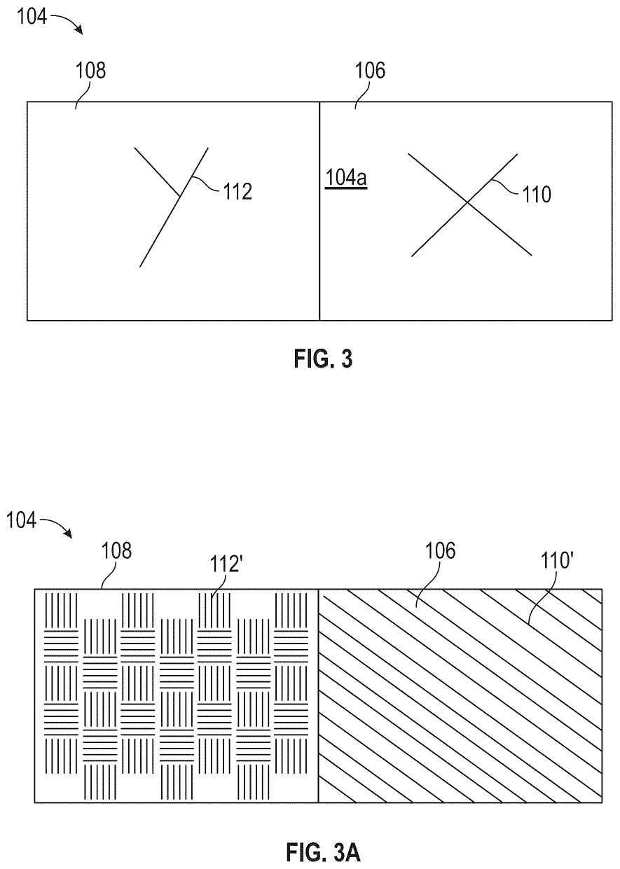

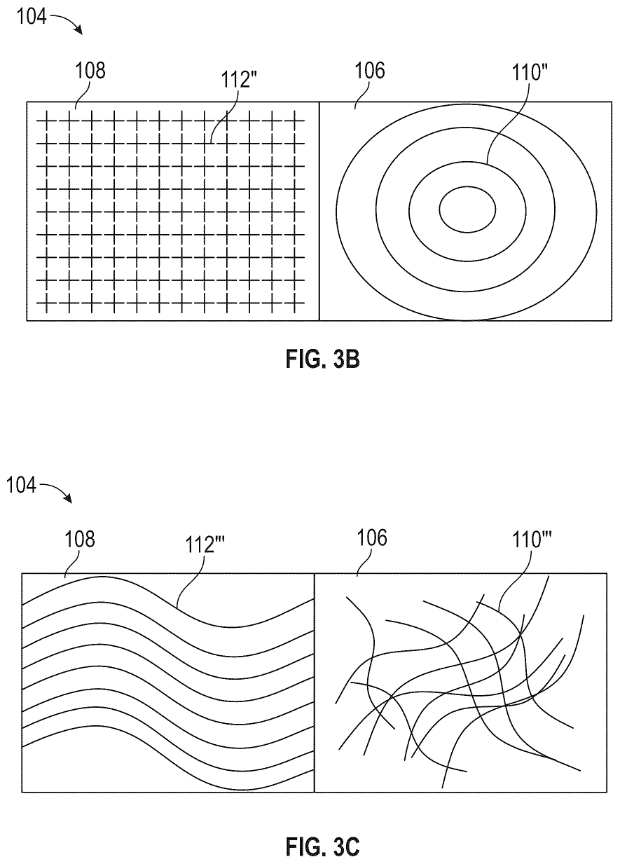

Each of FIGS. 3, 3a, 3b, and 3c illustrates an example of the moveable member 104 of the first example decoy 100. In the illustrated examples, the moveable member 104 is a rectangle; however, the moveable member 104 can be any shape including, but not limited to, a circle, square, triangle, trapezoid, rhombus, hexagon, wedge, octagon, pentagon, or the like. The moveable member 104 has a first region 106 and a second region 108. Although the illustrated examples depict only two regions, any number of regions can be present on the moveable member 104 including, but not limited to, one, two, three, four, ten, eleven, or twelve. The first region 106 has a first visual indicia 110, and the second region 108 has a second visual indicia 112. The second visual indicia 112 being different than the first visual indicia 110. The first and second visual indicia 110, 112 can be any type of pattern, template, design, scheme, style, format, or the like. The first and second visual indicia can be, but is not limited to, colors, black, white, reflective material, textures, or the like. The first visual indicia 110 being at least partially within the body 102 when the moveable member 104 is in a first position and at least partially outside the body 102 when the moveable member 104 is in a second position. The second visual indicia 112 being at least partially within the body 102 when the moveable member 104 is in the second position and at least partially within the body 102 when the moveable member 104 is in the first position.

FIG. 3 illustrates a Y and a X to indicate the two different indicia. The X and Y can comprise any desired illustration, note the use of the X and Y in the Figures is for illustration purposes only. For example, the indicia can be representative of the game animal represented by the decoy 100, such as a color or colors, pattern, outline, or other visually perceptible indicia typically found on the game animal represented by the decoy 100. A representation of the game animal which the decoy represents is not required in all examples, though; the first 110 and second 112 indicia need only be visually distinct from each other. FIG. 3a illustrates another example first 110′ and second 112′ indicia in which the first indicia 110′ comprises a series of diagonal line segments and the second indicia 112′ comprises a series of hatch marks. FIG. 3b illustrates another example first 110″ and second 112″ indicia in which the first indicia 110″ comprises a series of concentric circles and the second indicia 112″ comprises a series of crosses arranged in a grid pattern. FIG. 3c illustrates another example first 110′″ and second 112′″ indicia in which the first indicia 110″ comprises a pattern of random overlapping curvilinear line segments and the second indicia 112′″ comprises a series of adjacent, non-overlapping curvilinear line segments.

In operation of the first example decoy 100, wind or another source of moving air will move the moveable member 104 from the first position to the second position displaying different regions of the moveable member 104, i.e., the first region 106 and the second region 108. When the wind blows in the opposite direction, the moveable member 104 moves from the second position to the first position. The desired effect granted by the moving of the moveable member 104 is to display the different regions with the different indicia on each region. The change in which visual indicia that can be seen simulates the appearance and behavior of real animals. Thus, the simulation helps aid in the attraction of animals of that species, their predators, or other interested animals.

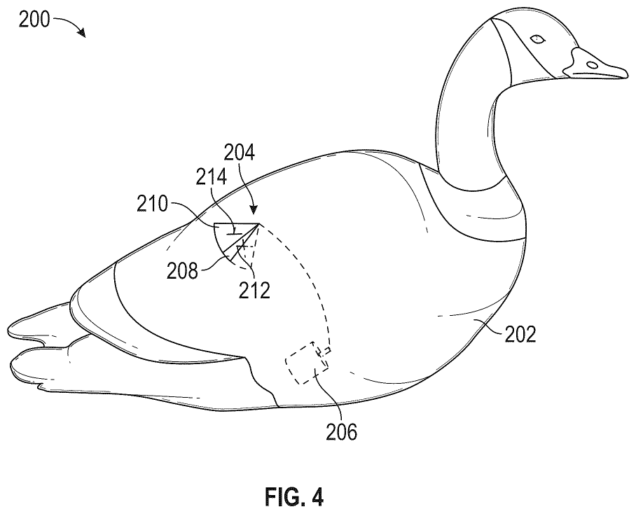

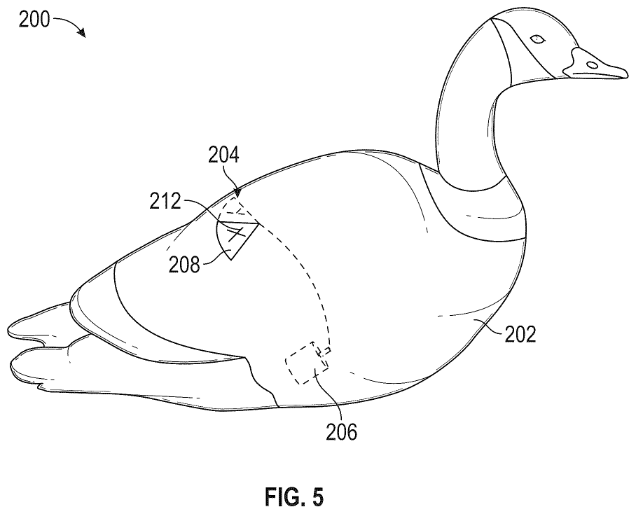

Each of FIGS. 4 and 5 illustrates a second example decoy 200. The decoy 200 has a body 202, a moveable member 204, and a motor 206. In the illustrated example, the decoy 200 is in the shape of a goose; however, the decoy 200 can be any type of animal including, but not limited to, a bear, elk, moose, caribou, wild boar, bison, mountain goat, turkey, pheasant, grouse, quail, duck, deer, rabbit, squirrel, coyote, alligator, raccoon, or the like.

The moveable member 204 is movable relative to the body 202 and is attached to, disposed within, or otherwise associated with the body 202 such that the movable member 204 can be moved relative to the body 202 to alternately permit and prevent visualization of the first 212 and second indicia 214 on a surface 204a of the movable member 204. The moveable member 204 can be moveably affixed to the body 202 in any desired manner so long as the moveable member 204 is moveable relative to the body 202 between a first position, as shown in FIG. 4, and a second position, as shown in FIG. 5. In the illustrated example, the moveable member 204 is partially disposed in the body 202 and the moveable member 204 is moved from the first position to the second position by the motor 206. However, the moveable member 204 can be moved by any means such as, but not limited to, an electric motor, wind, combustion engine, water, gravity, or the like. The motor 206 is in electrical communication with a power supply. The power supply can be any desired type of power supply including, but not limited to, batteries and solar panels. The decoy 200 in an alternative example can comprise a material having a clear and a blacked-out portion disposed over the moveable member 204. The material can be any type of suitable material such as a plastic.

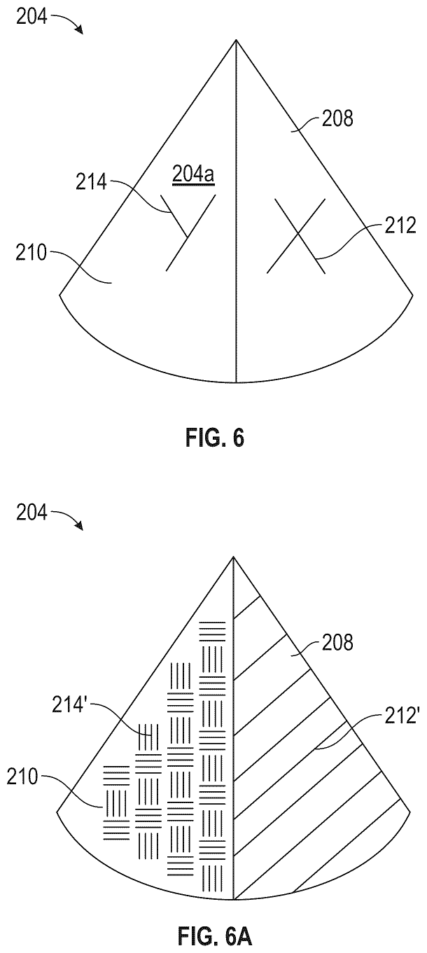

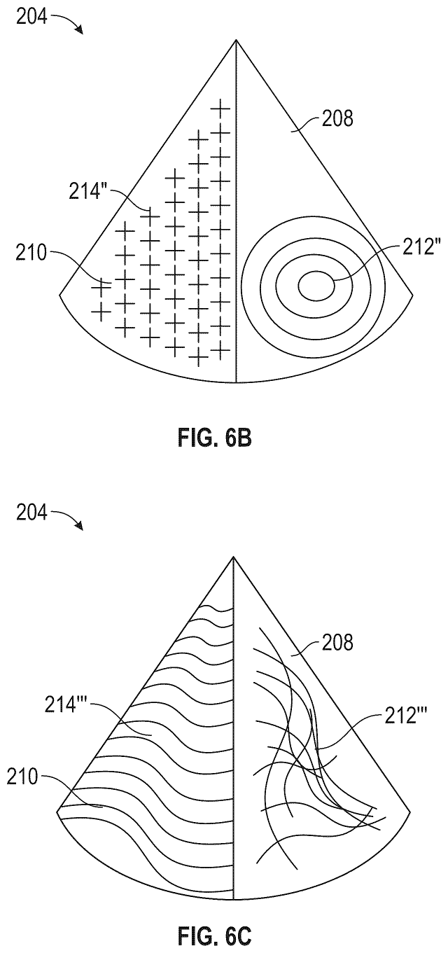

Each of FIGS. 6a, 6b, and 6c illustrates an example of the moveable member 204. In the illustrated examples, the moveable member 204 is a wedge; however, the moveable member 204 can be any shape including, but not limited to, a circle, square, rectangle, triangle, trapezoid, rhombus, hexagon, octagon, pentagon, or the like. The moveable member 204 has a first region 208 and a second region 210. Although the illustrated examples depict only two regions, any number of regions can be present on the moveable member 204 including, but not limited to, one, two, three, four, ten, eleven, or twelve. The first region 208 has the first visual indicia 212, and the second region 210 has the second visual indicia 214. The second visual indicia 214 being different than the first visual indicia 212. The first visual indicia 212 and second visual indicia 214 can be any type of pattern, template, design, scheme, style, or format. The first and second visual indicia 212, 214 can be, but is not limited to, colors, black, white, reflective material, textures, or the like. The first visual indicia 212 being at least partially within the body 202 when the moveable member 204 is in a first position and at least partially outside the body 202 when the moveable member 204 is in a second position. The second visual indicia 214 being at least partially within the body 202 when the moveable member 204 is in the second position and at least partially within the body 302 when the moveable member 304 is in the first position.

FIG. 6 illustrates a Y and a X to indicate the two different indicia. The X and Y can comprise any desired illustration, note the use of the X and Y in the Figures is for illustration purposes only. For example, the indicia can be representative of the game animal represented by the decoy 200, such as a color or colors, pattern, outline, or other visually perceptible indicia typically found on the game animal represented by the decoy 200. A representation of the game animal which the decoy 200 represents is not required in all examples, though; the first 212 and second 214 indicia need only be visually distinct from each other. FIG. 6a illustrates another example of first 212′ and second 214″ indicia in which the first indicia 212′ comprises a series of diagonal line segments and the second indicia 214′ comprises a series of hatch marks. FIG. 6b illustrates another example first 212″ and second 214″ indicia in which the first indicia 212″ comprises a series of concentric circles and the second indicia 214″ comprises a series of crosses arranged in a grid pattern. FIG. 6c illustrates another example first 212′″ and second 214′″ indicia in which the first indicia 212′″ comprises a pattern of random overlapping curvilinear line segments and the second indicia 214′″ comprises a series of adjacent, non-overlapping curvilinear line segments.

In operation, the motor 206 draws power from the power supply. The motor 206 then actuates the moveable member 204 from the first position to the second position. The motor 206 can then actuate the moveable member 204 to move from the second position to the first position. The movement of the moveable member 204 can continue in this pattern until a user turns off the decoy 200 by a switch, taking the batteries out, a remote control, or any other means. The desired effect granted by the moving of the moveable member 204 is to display the different regions 208, 212 with the different indicia 212, 214 at different times. The change in visual indicia that can be seen simulates the appearance and behavior of real animals. Thus, the simulation helps aid in the attraction of animals of that species, their predators, or other interested animals.

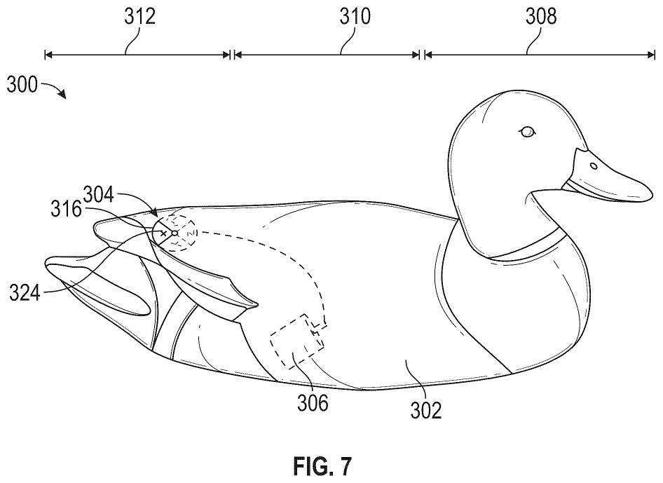

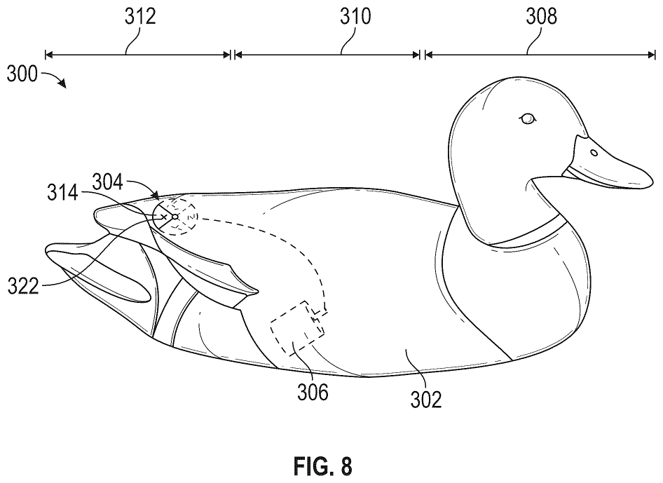

Each of FIGS. 7 and 8 illustrates a third example decoy 300. The decoy 300 has a body 302, a moveable member 304, and a motor 306. In the illustrated example, the decoy 300 is in the shape of a duck; however, the decoy 300 can be any type of animal including, but not limited to, a bear, elk, moose, caribou, wild boar, bison, mountain goat, turkey, pheasant, grouse, quail, goose, deer, rabbit, squirrel, coyote, alligator, raccoon, or the like. The body 302 of the decoy 300 has a head portion 308 connected to a body portion 310. The body portion 310 is connected to a tail portion 312.

The moveable member 304 is movable relative to the body 302 and is attached to, disposed within, or otherwise associated with the body 302 such that the movable member 304 can be moved relative to the body 302 to alternately permit and prevent visualization of the first 212 and second indicia 214 on a surface 304a of the movable member 304. The moveable member 304 can be moveably affixed to the body 302 in any desired manner so long as the moveable member 304 is moveable relative to the body 302 between a first position, as shown in FIG. 7, and a second position, as shown in FIG. 8. In the illustrated embodiment, the movable member 304 is a disk and is at least partially disposed in the tail portion 312 of the body 302. The moveable member 304 is moved from the first position to the second position by the motor 306. Although only two positions are illustrated, the moveable member can any number of positions. The moveable member 304 can be moved by any type of means such as an electric motor, wind, combustion engine, water, gravity, or the like. In the illustrated embodiment, the motor is in electrical communication with a power supply. The power supply can be any desired type of power supply including, but not limited to, batteries and solar panels.

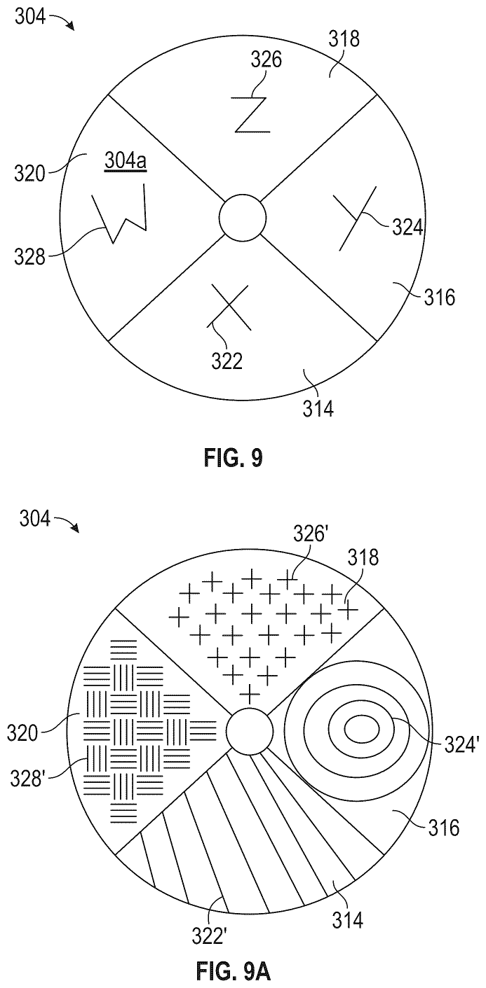

Each of FIGS. 9 and 9a illustrates an example of the moveable member 304. In the illustrated examples, the moveable member 304 is a flat disk; however, the moveable member 304 can have any suitable shape and configuration including, but not limited to, a circle, square, rectangle, triangle, trapezoid, rhombus, hexagon, octagon, pentagon, wedge, or the like. The moveable member 304 has a first region 314, a second region 316, a third region 318, and a fourth region 320. Although the illustrated embodiment depicts four regions, any number of regions can be present in or on the moveable member 304 including, but not limited to, more than one, two, a plurality, three, four, five, six, seven, eight, nine, ten, eleven, and twelve. In each embodiment, each region for the number of regions included advantageously has an indicia associated with it that is different from all other indicia associated with the other regions on the movable member. At a minimum, no matter the number of regions, at least two indicia must be included on two different regions, and at least two of indicia must be different from each other. In the illustrated example, the first region 314 has a first visual indicia 322. The second region 316 has a second visual indicia 324. The third region 318 has a third visual indicia 326. The fourth region 320 has a fourth visual indicia 328. In the illustrated embodiment, all of the visual indicia are different; however, not all of the visual indicia need to be different. For example, there can be one visual indicia that is different than the other three, there can be two visual indicia that are the same, all the visual indicia can be the same but have a repeating pattern or design, or any other desired visual configuration. The visual indicia 322, 324, 326, 328 can be any type of pattern, template, design, scheme, style, or format. The visual indicia 322, 324, 326, 328 can be, but is not limited to, colors, black, white, reflective material, textures, or the like. The first visual indicia 322 being at least partially within the body 302 when the moveable disk 304 is in a first position and at least partially outside the body 302 when the moveable disk 304 is in a second position. The second visual indicia 324 being at least partially within the body 302 when the moveable disk 304 is in the second position and at least partially within the body 302 when the moveable disk 304 is in the first position. The third visual indicia 326 being at least partially within the body 302 when the moveable disk 304 is in a third position and at least partially within the body 302 when the moveable disk 304 is in the second position. The fourth visual indicia 328 being at least partially within the body 302 when the moveable disk 304 is in a fourth position and at least partially within the body 302 when the moveable disk 304 is in the third position.

FIG. 9 illustrates a Y, X, Z, and W to indicate the four different indicia. The Y, X, Z, and W can comprise any desired illustration, note the use of the Y, X, Z, and W in the Figures is for illustration purposes only. For example, the indicia can be representative of the game animal represented by the decoy 300, such as a color or colors, pattern, outline, or other visually perceptible indicia typically found on the game animal represented by the decoy 300. A representation of the game animal which the decoy 300 represents is not required in all examples, though; only one of the first 322, second 324, third 326, and fourth 328 indicia need be visually distinct from the others. FIG. 9a illustrates another example of first 322′, second 324′, third 326′, and fourth 328′ indicia in which the first indicia 322′ comprises a series of diagonal line segments; the second indicia 324′ comprises a series concentric circles; the third indicia 326′ comprises a series of crosses arranged in a grid pattern; and the fourth indicia 328′ comprises a series of hatch marks

In operation, the motor 306 draws power from the power supply. The motor 306 then actuates the moveable member 304, about an axis, from the first position to the second position. The motor 306 then can actuate the moveable member 304 to move from the second position to a third position and then to a fourth position. Once the moveable member 304 reaches the fourth position, it can return to the first position by continuing in the same direction. The movement of the moveable member 304 can continue in this pattern until a user turns off the decoy 300 by a switch, taking the batteries out, a remote control, or any other means. The movement of the moveable member 304 can also be configured to oscillate rather than spin in one direction. For example, the moveable member 304 can go from the first position, past the second and third positions, to the fourth position. Then, the moveable member 304 can spin in the opposite direction to go back to the first position. The desired effect granted by the moving of the moveable member 304 is to display the different regions 314, 316, 318, 320 with the different indicia 322, 324, 326, 328 on each region. The change in visual indicia simulates the appearance and behavior of real animals. Thus, the simulation helps aid in the attraction of animals of that species, their predators, or other interested animals.

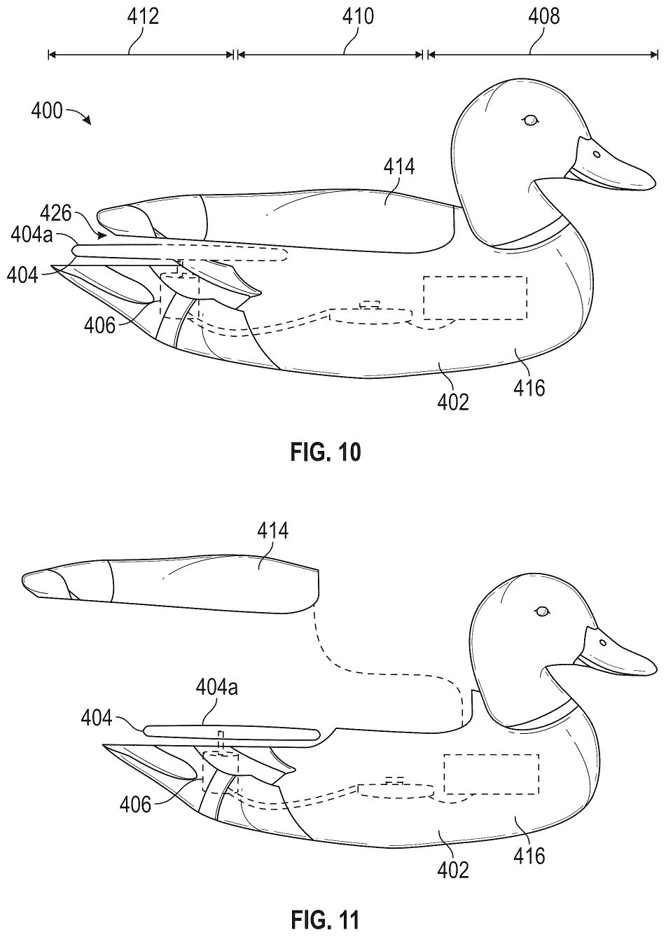

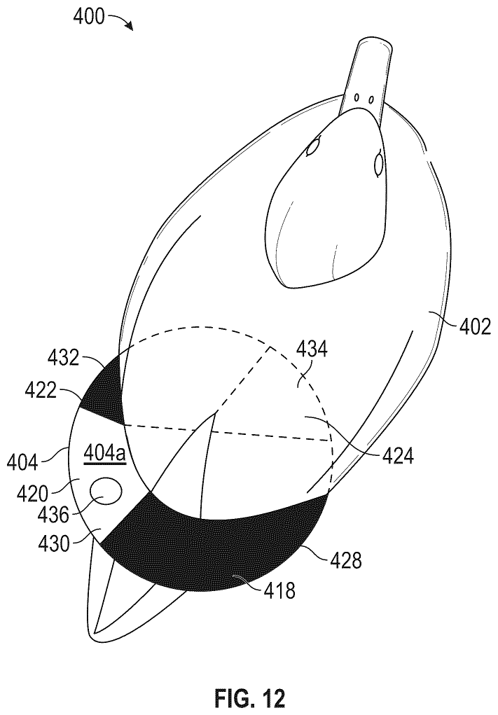

Each of FIGS. 10, 11, and 12 illustrates a fourth example decoy 400. The decoy 400 has a body 402, a moveable member 404, and a motor 406. In the illustrated example, the decoy 400 is in the shape of a duck; however, the decoy 400 can be any type of animal including but not limited to, a bear, elk, moose, caribou, wild boar, bison, mountain goat, turkey, pheasant, grouse, quail, goose, deer, rabbit, squirrel, coyote, alligator, raccoon, or the like. The body 402 of the decoy 400 has a head portion 408 connected to a body portion 410. The body portion 410 is connected to a tail portion 412. The body 402 also has a top portion 414 that is removably connected to a bottom portion 416. The top portion 414 and bottom portion 416 can be connected by any means. One example of how the top portion 414 and the bottom portion 416 can be connected is by magnets; however, any other desired means of attachment can be present. The top portion 414 and the bottom portion 416 need not be removably connected, but the top portion 414 and bottom portion 416 being removeable allows the moveable member 404 be replaced with a moveable member that has different indicia thereon.

The moveable member 404 is movable relative to the body 402 and is attached to, disposed within, or otherwise associated with the body 402 such that the moveable member 404 can be moved relative to the body 402 to alternately permit and prevent visualization of a first 418, second 420, third 422, and fourth visual indicia 424 on a surface 404a of the moveable member 404. The moveable member 404 can be moveably affixed to the body 402 in any desired manner so long as the moveable member 404 is moveable relative to the body 402 between a first position and a second position. The fourth example decoy 400 may further include a weight 436 disposed on or otherwise attached to the moveable member 404, or the motor 406, by any means necessary. In the illustrated embodiment, the moveable member 404 is a disk and is partially disposed in the tail portion 412 of the body 402 in a slot 426. The moveable member 404 is moved from the first position to the second position by the motor 406. Although only two positions are illustrated, the moveable member 404 can be any number of positions. The moveable member 404 can be moved by any type of means such as an electric motor, wind, combustion engine, water, gravity, or the like. In the illustrated embodiment, the motor 406 is in electrical communication with a power supply. The power supply can be any desired type of power supply including, but not limited to, batteries and solar panels.

In the illustrated example, the moveable member 404 is a flat disk; however, the moveable member 404 can have any suitable shape and configuration including, but not limited to, a circle, square, rectangle, triangle, trapezoid, rhombus, hexagon, octagon, pentagon, wedge, or the like. The moveable member 404 has a first region 428 and a second region 430. Although the illustrated embodiment depicts four regions, any number of regions can be present in or on the movable member 404 including, but not limited to, more than one, a plurality, two, three, five, six, seven, eight, nine, ten, eleven, and twelve. In each embodiment, each region for the number of regions included advantageously has an indicia associated with it. In the illustrated embodiment, the first and third visual indicia 418, 422 are the same visual indicia, and the second and fourth visual indicia 420, 424 are the same visual indicia. However, the second and fourth visual indicia 420, 424 are different than the first and third visual indicia 418, 422. At a minimum, no matter the number of regions, at least two indicia must be included on two different regions, and at least two of the indicia must be different from each other. In the illustrated embodiment, the first region 428 has a first visual indicia 418. The second region 430 has a second visual indicia 420. The third region 432 has a third visual indicia 422. The fourth region 434 has a fourth visual indicia 424. In the illustrated embodiment, the first and third visual indicia 418, 422 are black and the second and third visual indicia 420, 424 are white. However, the visual indicia 418, 420, 422, 424 can be any type of pattern template, design, scheme, style, or format. The visual indicia 418, 420, 422, 424 can be, but is not limited to, colors, reflective materials, textures, or the like. The first visual indicia 418 being at least partially within the body 402 when the moveable disk 404 is in a first position and at least partially outside the body 402 when the moveable disk 404 is in a second position. The second visual indicia 420 being at least partially within the body 402 when the moveable disk 404 is in the second position and at least partially within the body 402 when the moveable disk 404 is in the first position.

In operation, the motor 406 draws power from the power supply. The motor 406 then actuates the moveable member 404, about an axis, from the first position to the second position. The motor 406 then can actuate the moveable member 404 to move from the second position to the first position. As the motor actuates the moveable member 404, the weight 436 also moves from the first position to the second position. As the weight 436 moves, the center of gravity shifts within the fourth example decoy 400 and causes the fourth example decoy 400 to oscillate. The oscillation of the fourth example decoy 400 causes waves or other motions of the water depending on the speed that the moveable member is moving at. This motion makes the fourth example decoy 400 to appear as if it is moving in the water to give an illusion that the fourth example decoy 400 is a real duck. The rotation of the moveable member 404 can be constant, user selected, variable, or the like. The rotation of the moveable member 404 can also be any desired speed. The rotation of the moveable member 404 can continue in a pattern until a user turns off the decoy 400 by a switch, taking the batteries out, a remote control, or any other means. The movement of the moveable member 404 can also be configured to oscillate rather than spin in one direction. For example, the moveable member 404 can go from the first position to the second position and reverse direction then go back to the first position. The desired effect granted by the moving of the moveable member 404 is to display the different regions 428, 430, 432, 434. In the illustrated embodiment, the black and white regions are seen as advantageous because when viewed from above, as seen in FIG. 11, the movement of the moveable member 404 resembles the fluttering of the tail of a living duck. The decoy 400 can be on the water or on land. If the duck is on water, the rotation of the moveable member 404 can cause the water to ripple under the duck to appear as if the decoy 400 is moving. The change in visual indicia simulates the appearance and behavior of real animals. Thus, the simulation helps aid in the attraction of animals of that species, their predators, or other interested animals.

FIG. 13 illustrates an example decoy system including the third example decoy 300. The decoy system includes at least one remote control 500 that is in operative communication with the motor 306 of the decoy 300. Although only one remote control is illustrated, the decoy system can include any number of remote controls 500 including, but not limited to, two, three, four, six, twelve, or twenty. If there is more than one remote control 500, each remote control can perform similar functions or different. For example, the different remote controls 500 can be programmed to control different decoys 300 or each remote control 500 can control all the decoys 300 but control a different function. The decoy system must include at least one decoy 300. However, the decoy system can include any suitable number of decoys 300, including but not limited to, two, three, four, six, twelve, or twenty. The decoys in the decoy system can be any embodiment of decoys. The remote control 500 can be capable of controlling several functions of the decoy system. One possible function is the starting and stopping of one or all the decoys 300 with a single action by a user of the remote control 500. This can be accomplished by allowing all of the decoys 300 to receive the same frequency of waves or by any other means. Another function that the decoy system can have is the remote control 500 can be configured to output several different frequencies so that the user of the system can choose which decoys 300 are operating at a given time. The remote control 500 can switch frequencies by a switch, a button, or by any other desired means. Likewise, the decoys 300 can have a means to change which frequency in which it operates. Another function that the remote control 500 can have is the remote control 500 can adjust the speed of the motor. This causes the rotation of the moveable disk 304 to change based on input by the user.

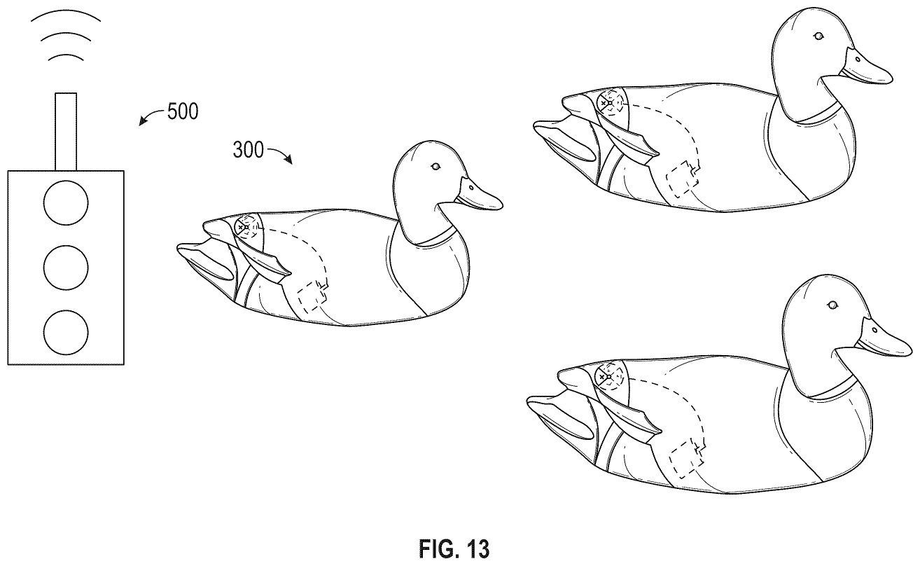

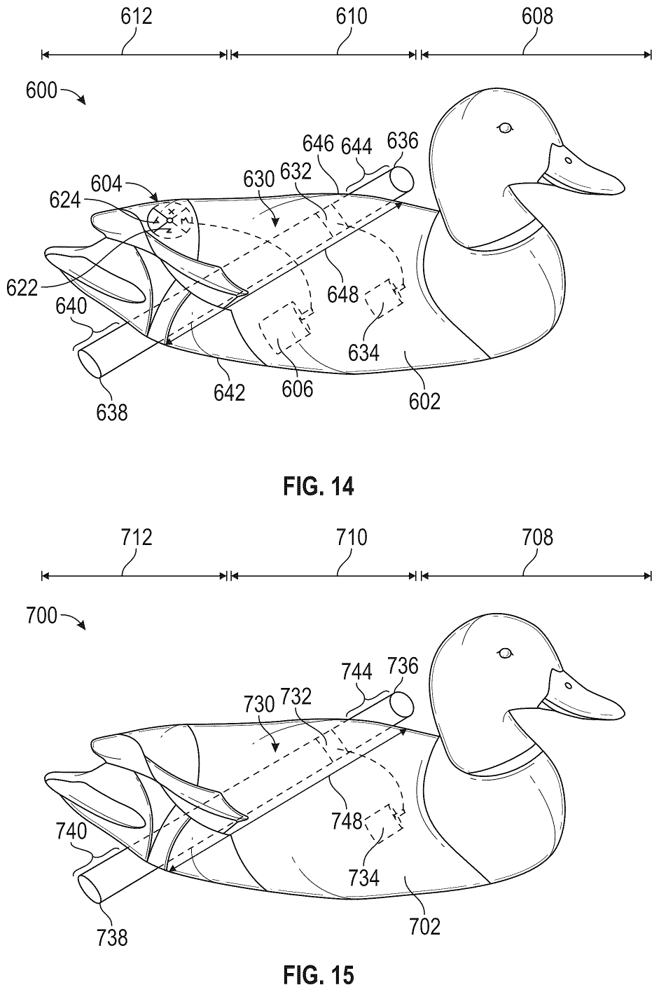

FIG. 14 illustrates a fifth example decoy 600. The decoy 600 has a body 602, a moveable member 604, a tubular member 630, a fan 632, a first motor 606, and a second motor 634. In the illustrated example, the decoy 600 is in the shape of a duck; however, the decoy 600 can be any type of animal including, but not limited to, a bear, elk, moose, caribou, wild boar, bison, mountain goat, turkey, pheasant, grouse, quail, goose, deer, rabbit, squirrel, coyote, alligator, raccoon, or the like. The body 602 of the decoy 600 has a head portion 608 connected to a body portion 610. The body portion 610 is connected to a tail portion 612.

The moveable member 604 is movable relative to the body 602 and is attached to, disposed within, or otherwise associated with the body 602 such that the movable member 604 can be moved relative to the body 602 to alternately permit and prevent visualization of the first 622 and second indicia 624 on a surface 604a of the movable member 604. The moveable member 604 can be moveably affixed to the body 602 in any desired manner so long as the moveable member 604 is moveable relative to the body 602 between a first position and a second position. Examples of the first position and second position are identical to the positions in FIGS. 7 and 8. In the illustrated embodiment, the movable member 604 is a disk and is at least partially disposed in the tail portion 612 of the body 602. The moveable member 604 is moved from the first position to the second position by the first motor 606. Although only two positions are described, the moveable member can any number of positions. The moveable member 604 can be moved by any type of means such as an electric motor, wind, combustion engine, water, gravity, or the like. In the illustrated embodiment, the first motor 606 is in electrical communication with a power supply. The power supply can be any desired type of power supply including, but not limited to, batteries and solar panels.

In the illustrated embodiment, the tubular member 630 extends from a proximal end 636 to a distal end 638. The tubular member 630 is attached to, disposed within, or otherwise associated with the body 602. A distal portion 640 of the tubular member 630 extends from a bottom surface 642 of the decoy in a direction away from the body 602 of the decoy 600. The tubular member 630 further extends in an opposite direction, and a proximal portion 644 protrudes from a top surface 646 of the decoy 600. In alternative embodiments, the distal portion 640 and the proximal portion 644 do not extend past the surface of the decoy 600. An intermediate portion 648 is disposed within the body 602 of the decoy 600. Disposed within the tubular member is the fan 632. Although the fan 632 is illustrated as being disposed within the tubular member 630, the fan 632 could also be disposed on the proximal end 636 of the tubular member 630 or any other desired location so long as air is being drawn through the tubular member 630 and expelled through the distal end 638 of the tubular member 630. The fan 632 can be powered by any means such as an electric motor, wind, combustion engine, water, gravity, or the like. In the illustrated embodiment, the fan 632 is in communication with the second motor 634, and the second motor 634 is in electrical communication with a power supply. The power supply can be any desired type of power supply including, but not limited to, batteries and solar panels. The fan in combination with the tubular member 630 is configured to draw air in from an environment surrounding the proximal end 636 of the tubular member 630 and expel the air from the distal end 638 of the tubular member 630. The air being blown from the proximal end 636 of the tubular member 630 to the distal end 638 of the tubular member 630 is used to mimic the movement of a duck swimming on a body of water by moving the decoy 600 and producing wake that follows the decoy 600 as it moves through the body of water. Although the decoy 600 is illustrated as having only one fan 632, any number of fans 632 can be used including, but not limited to, two, three, and four.

Each of FIGS. 9 and 9a illustrates an example of the moveable member 304; however, the movable member 604 is identical to the moveable member 304. Therefore, FIGS. 9 and 9a are an accurate indication of how moveable member 604 operates. In the illustrated examples, the moveable member 304 is a flat disk; however, the moveable member 304 can have any suitable shape and configuration including, but not limited to, a circle, square, rectangle, triangle, trapezoid, rhombus, hexagon, octagon, pentagon, wedge, or the like. The moveable member 304 has a first region 314, a second region 316, a third region 318, and a fourth region 320. Although the illustrated embodiment depicts four regions, any number of regions can be present in or on the moveable member 304 including, but not limited to, more than one, two, a plurality, three, four, five, six, seven, eight, nine, ten, eleven, and twelve. In each embodiment, each region for the number of regions included advantageously has an indicia associated with it that is different from all other indicia associated with the other regions on the movable member. At a minimum, no matter the number of regions, at least two indicia must be included on two different regions, and at least two of indicia must be different from each other. In the illustrated example, the first region 314 has a first visual indicia 322. The second region 316 has a second visual indicia 324. The third region 318 has a third visual indicia 326. The fourth region 320 has a fourth visual indicia 328. In the illustrated embodiment, all of the visual indicia are different; however, not all of the visual indicia need to be different. For example, there can be one visual indicia that is different than the other three, there can be two visual indicia that are the same, all the visual indicia can be the same but have a repeating pattern or design, or any other desired visual configuration. The visual indicia 322, 324, 326, 328 can be any type of pattern, template, design, scheme, style, or format. The visual indicia 322, 324, 326, 328 can be, but is not limited to, colors, black, white, reflective material, textures, or the like. The first visual indicia 322 being at least partially within the body 302 when the moveable disk 304 is in a first position and at least partially outside the body 302 when the moveable disk 304 is in a second position. The second visual indicia 324 being at least partially within the body 302 when the moveable disk 304 is in the second position and at least partially within the body 302 when the moveable disk 304 is in the first position. The third visual indicia 326 being at least partially within the body 302 when the moveable disk 304 is in a third position and at least partially within the body 302 when the moveable disk 304 is in the second position. The fourth visual indicia 328 being at least partially within the body 302 when the moveable disk 304 is in a fourth position and at least partially within the body 302 when the moveable disk 304 is in the third position.

FIG. 14 illustrates a sixth example decoy 700. The decoy 700 has a body 702, a tubular member 730, a fan 732, and a motor 734. In the illustrated example, the decoy 700 is in the shape of a duck; however, the decoy 700 can be any type of animal including, but not limited to, a bear, elk, moose, caribou, wild boar, bison, mountain goat, turkey, pheasant, grouse, quail, goose, deer, rabbit, squirrel, coyote, alligator, raccoon, or the like. The body 702 of the decoy 700 has a head portion 708 connected to a body portion 710. The body portion 710 is connected to a tail portion 712.

In the illustrated embodiment, the tubular member 730 extends from a proximal end 736 to a distal end 738. The tubular member 730 is attached to, disposed within, or otherwise associated with the body 702. A distal portion 740 of the tubular member 730 extends from a bottom surface 742 of the decoy in a direction away from the body 702 of the decoy 700. The tubular member 730 further extends in an opposite direction, and a proximal portion 744 protrudes from a top surface 746 of the decoy 700. In alternative embodiments, the distal portion 740 and the proximal portion 744 do not extend past the surface of the decoy 700. An intermediate portion 748 is disposed within the body 702 of the decoy 700. Disposed within the tubular member is the fan 732. Although the fan 732 is illustrated as being disposed within the tubular member 730, the fan 732 could also be disposed on the proximal end 736 of the tubular member 730 or any other desired location so long as air is being drawn through the tubular member 730 and expelled through the distal end 738 of the tubular member 730. The fan 732 can be powered by any type of means such as an electric motor, wind, combustion engine, water, gravity, or the like. In the illustrated embodiment, the fan 732 is in communication with the motor 734, and the motor 734 is in electrical communication with a power supply. The power supply can be any desired type of power supply including, but not limited to, batteries and solar panels. The fan in combination with the tubular member 730 is configured to draw air in from an environment surrounding the proximal end 736 of the tubular member 730 and expel the air from the distal end 738 of the tubular member 730. The air being blown from the proximal end 736 of the tubular member 730 to the distal end 738 of the tubular member 730 is used to mimic the movement of a duck swimming on a body of water by moving the decoy 700 and producing wake that follows the decoy 700 as it moves through the body of water. Although the decoy 700 is illustrated as having only one fan 732, any number of fans 732 can be used including, but not limited to, two, three, and four.

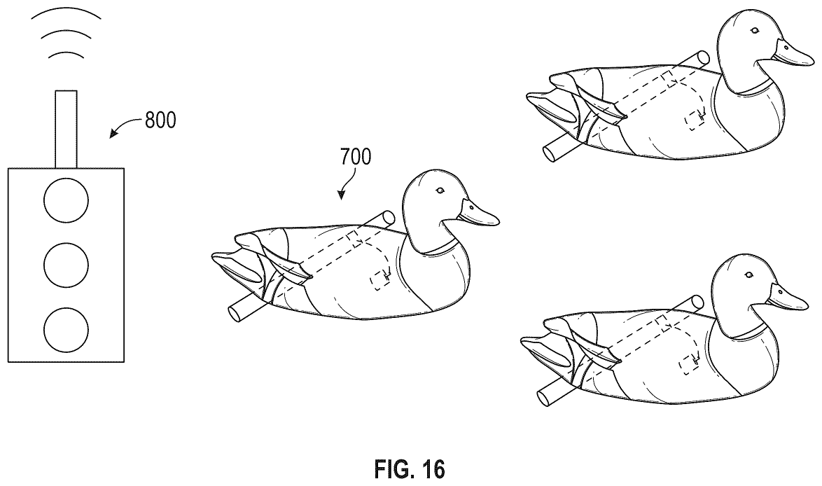

FIG. 16 illustrates an example decoy system including the sixth example decoy 700. The sixth decoy 700 can be replaced with any of the previously mentioned decoys or included in the example decoy system. The decoy system includes at least one remote control 800 that is in operative communication with the motor 734 of the decoy 700. Although only one remote control is illustrated, the decoy system can include any number of remote controls 800 including, but not limited to, two, three, four, six, twelve, or twenty. If there is more than one remote control 800, each remote control can perform similar functions or different. For example, the different remote controls 800 can be programmed to control different decoys 700 or each remote control 800 can control all the decoys 700 but control a different function. The decoy system must include at least one decoy 700. However, the decoy system can include any suitable number of decoys 700, including but not limited to, two, three, four, six, twelve, or twenty. The decoys in the decoy system can be any embodiment of decoys. The remote control 800 can be capable of controlling several functions of the decoy system. One possible function is the starting and stopping of one or all the decoys 700 with a single action by a user of the remote control 800. This can be accomplished by allowing all of the decoys 700 to receive the same frequency of waves or by any other means. Another function that the decoy system can have is the remote control 800 can be configured to output several different frequencies so that the user of the system can choose which decoys 700 are operating at a given time. The remote control 800 can switch frequencies by a switch, a button, or by any other desired means. Likewise, the decoys 700 can have a means to change which frequency in which it operates. Another function that the remote control 800 can have is the remote control 800 can adjust the speed of the motor 734. This causes the rotation of the fan 734 to change based on input by the user.

Further, the decoy 700 in the example decoy system, illustrated in FIG. 15, can be replaced by the decoy 600. The decoy 600 has the tubular member 730 of the decoy 700; however, the decoy 600 further has the moveable member 604 as well. In this case, the remote control 800 or multiple remote controls 800 can be configured to operate all or just one of the decoys 600. For example, the remote control 800 can slow down the first motor 606 and/or the second motor 634. This can cause the rotation of the fan 634 and/or the moveable member 604 to change based on input by the user.

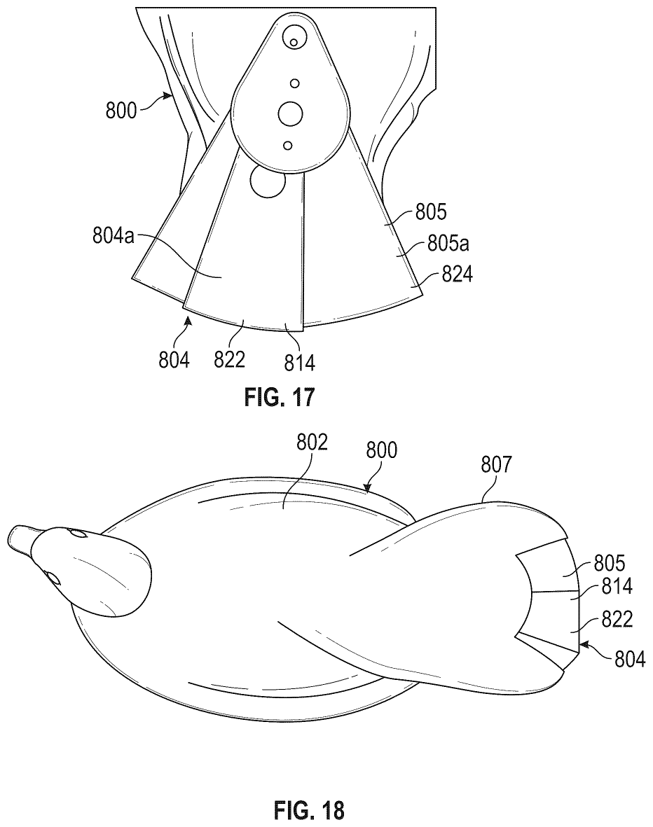

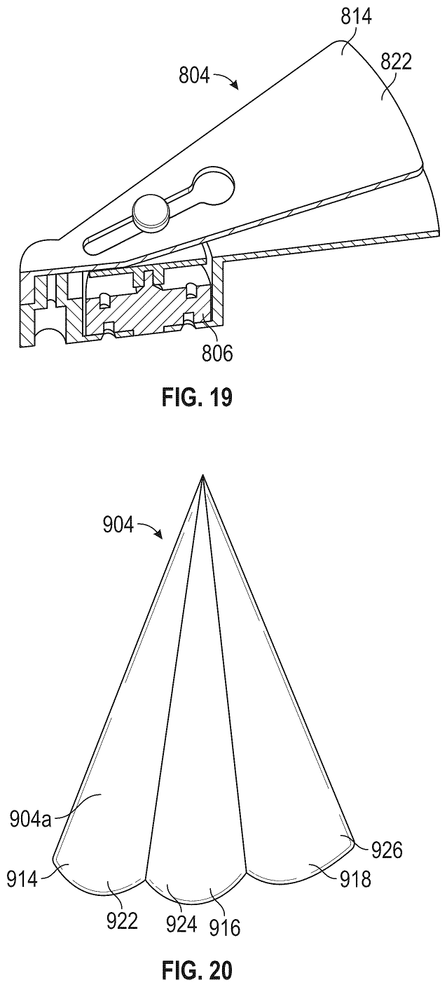

Each of FIGS. 17, 18, and 19 illustrates a first example of a detachable moveable member 804 that can be attached and detached from any desired decoy. Although the moveable member 804 is not illustrated as being removed from a decoy, the moveable member 804 is configured to be attached to any existing decoy. In the illustrated embodiment, the detachable moveable member 804 is relatively wedge shaped; however, the detachable moveable member 804 can be the same shape as any of the preceding moveable members described above. Although the illustrated embodiment depicts a duck decoy 800, the detachable moveable member 804 can be used for any type of decoy including, but not limited to, bear, elk, moose, caribou, wild boar, bison, mountain goat, turkey, pheasant, grouse, quail, duck, deer, rabbit, squirrel, coyote, alligator, raccoon, or the like. The detachable moveable member 804 can be attached directly to the decoy 800, as seen in FIG. 17, or the detachable moveable member 804 can be disposed within a housing 807 that is attached to a body 802 of the decoy 800, as seen in FIG. 18. Although not illustrated, the housing 807 is configured to be removed and attached from any existing decoy.

The decoy 800 has the body 802, and the detachable moveable member 804 is movable relative to the body 802 such that the detachable movable member can be moved relative to the body 802 to alternately permit and prevent visualization of a first visual indicia 822 and a second visual indicia 824. The first visual indicia 822 is on a surface 804a of the detachable movable member, and the second visual indicia 824 is on a surface 805a of a base 805 in which the detachable moveable member 804 is disposed. The detachable moveable member 804 can be moveably affixed to the body 802 in any desired manner so long as the detachable moveable member 804 is moveable relative to the body 802 between a first position and a second position. In the illustrated examples, the detachable moveable member 804 is moved from the first position to the second position by a motor 806. However, the detachable moveable member 804 can be moved by any means such as, but not limited to, an electric motor, wind, combustion engine, water, gravity or the like. The motor 806 is in electrical communication with a power supply. The power supply can be any desired type of power supply including, but not limited to, batteries and solar panels.

In the illustrated examples, the detachable moveable member 804 is a wedge; however, the detachable moveable member 804 can be any shape including, but not limited to, a circle, square, rectangle, triangle, trapezoid, rhombus, hexagon, octagon, pentagon, or the like. The detachable movable member has a singular region 814. Although the illustrated example depicts only the singular region 814, any number of regions can be present on the detachable moveable member 804 including but not limited to, two, three, four, ten, eleven, or twelve. The singular region 814 has the first visual indicia 822, and the base 805 has the second visual indicia 824. The second visual indicia 824 being different than the first visual indicia 822. The first visual indicia 822 and the second visual indicia 824 can be any type of pattern, template, design, scheme, style, or format. The first and second visual indicia 822, 824 can be, but is not limited to, colors, black, white, reflective material, textures, or the like. The second visual indicia 824 being at least partially hidden when the detachable moveable member 804 is in a first position and at least partially not hidden when the detachable moveable member 804 is in a second position. The first visual indicia 822 being at least partially hidden, when the housing 807 is present, when the detachable moveable member 804 is in the second position and at least partially not hidden when the detachable moveable member 804 is in the first position. The first visual indicia 822 and the second visual indicia 824 can comprise any desired illustration including, but not limited to, those illustrated in FIG. 3, 3a, 3b, 3c, 6, 6a, 6b, 6c, 9, or 9a. For example, the visual indicia can be representative of the game animal represented by the decoy 800, such as color or colors, pattern, outline, or other visually perceptible visual indicia typically found on the game animal represented by the decoy 800. A representation of the game animal which the decoy 800 represents is not required in all examples though; the first and second visual indicia 822, 824 need only be visually distinct from each other.

In operation, the motor 806 draws power from the power supply. The motor 806 then actuates the detachable moveable member 804 from the first position to the second position. The motor 806 can then actuate the detachable moveable member 804 to move from the second position to the first position. The movement of the detachable moveable member 804 can continue in this pattern until a user turns off the decoy 800 by a switch, taking the batteries out, a remote control, or by any other means. The desired effect granted by the moving of the detachable moveable member 804 is to display the different visual indicia at different times. The change in visual indicia that can be seen simulates the appearance and behavior of real animals. Thus, the simulation helps aid in the attraction of animals of that species, their predators, or other interesting animals.

FIG. 20 illustrates, a second example detachable moveable member 904 having a first region 914, a second region 916, and a third region 918. The detachable moveable member 904 illustrated in FIG. 20 can replace the detachable moveable member 804 illustrated in each of FIGS. 17, 18, and 19. In the illustrated example, the detachable moveable member 904 is a wedge; however, the detachable moveable member 904 can be any shape including, but not limited to, a circle, square, rectangle, triangle trapezoid, rhombus, hexagon, octagon, pentagon, or the like. The moveable member 904 has a first region 914, a second region 916, and a third region 918. Although the illustrated example depicts only three regions, any number of regions can be present on the detachable moveable member 904 including, but not limited to, one, two, four, ten, eleven, or twelve. The first region 914 has a first visual indicia 922, the second region 916 has a second visual indicia 924, and the third region 918 has a third visual indicia 926. Each of the first visual indicia 922, the second visual indicia 924, and the third visual indicia 926 having a visual indicia that is different from the other. The first visual indicia 922, the second visual indicia 924, and the third visual indicia 926 can be any type of pattern, template, design, scheme, style, or format. The first, second and third visual indicia can be, but is not limited to, colors, black, white, reflective material, textures or the like. The first visual indicia 922 being at least partially hidden when the detachable moveable member 904 is in a first position, and partially not hidden when the detachable moveable member 904 is in a second position. The second visual indicia 924 being at least partially not hidden when the detachable moveable member 904 is in the first position and the second position. The third visual indicia 926 being at least partially hidden in the second position and at least not partially hidden in the first position. In alternative embodiments, none of the first visual indicia 922, the second visual indicia 924, or the third visual indicia 926 are hidden at all. In such embodiments, the detachable moveable member 904 oscillates from the first position to the second position to mimic movement of a game animal.

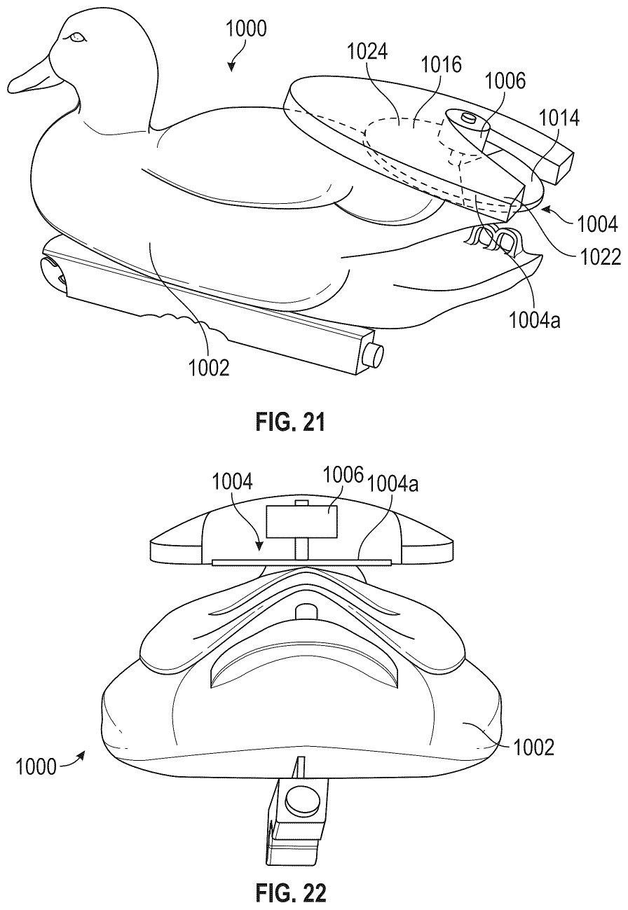

Each of FIGS. 21 and 22 illustrates a third example detachable moveable member 1004 that can be attached and detached from any desired decoy. Although the moveable member 1004 is not illustrated as being removed from a decoy, the moveable member 1004 is configured to be attached to any existing decoy. In the illustrated embodiment, the detachable member is circular; however, the detachable moveable member 1004 can be the same shape as any of the preceding moveable members described above. Although the illustrated embodiment depicts a duck decoy 1000, the detachable moveable member 1004 can be used for any type of decoy including, but not limited to, bear, elk, moose, caribou, wild boar, bison, mountain goat, turkey, pheasant, grouse, quail, duck, deer, rabbit, squirrel, coyote, alligator, raccoon, or the like. The detachable moveable is disposed within the housing 1007 and is attached to the decoy 1000. Although not illustrated, the housing 1007 is configured to be removed and attached from any existing decoy. In alternative embodiments, the detachable moveable member 1004 is attached directly to a body 1002 of the decoy 1000.

The detachable member is movable relative to the body 1002 such that the detachable moveable member 1004 can be moved relative to the body 1002 to alternately permit and prevent visualization of a first visual indicia 1022 and a second visual indicia 1024. The first visual indicia 1022 is on a first region 1014 of a surface 1004a of the detachable moveable member 1004, and the second visual indicia 1024 is on a second region 1016 of the surface 1004a of the detachable moveable member 1004. The detachable moveable member 1004 can be moveably affixed to the body 1002 in any desired manner so long as the detachable moveable member 1004 is moveable relative to the body 1002 between a first position and a second position. In the illustrated examples, the detachable moveable member 1004 is moved from the first position to the second position by a motor 1006. However, the detachable moveable member 1004 can be moved by any means such as, but not limited to, an electric motor, wind, combustion engine, water, gravity, or the like. The motor 1006 is in electrical communication with a power supply. The power supply can be any desired type of power supply including, but not limited to, batteries and solar panels.

In the illustrated embodiment, the detachable moveable member 1004 is circular; however, the detachable moveable member 1004 can be any shape including, but not limited to, a square, rectangle, triangle, wedge, trapezoid, rhombus, hexagon, octagon, pentagon, or the like. The detachable moveable member 1004 includes the first region 1014 and the second region 1016. Any number of regions can be present on the detachable moveable member 1004 including but not limited to, one, three, four, ten, eleven, or twelve. As mentioned above, the first region 1014 includes the first visual indicia 1022, and the second region 1016 includes the second visual indicia 1024. The second visual indicia 1024 being different than the first visual indicia 1022. The first visual indicia 1022 and the second visual indicia 1024 can be any typo f pattern, template, design, scheme, style, or format. The first and second visual indicia 1024 can be, but is not limited to, colors, black, white, reflective material, textures, or the like. The first visual indicia 1022 being at least partially hidden when the detachable moveable member 1004 is in a first position and at least partially not hidden when the detachable moveable member 1004 is in a second position. The second visual indicia 1024 being at least partially hidden when the detachable moveable member 1004 is in the second position and at least partially not hidden when the detachable moveable member 1004 is in the first position. The first visual indicia 1022 and the second visual indicia 1024 can comprise any desired illustration including, but not limited to, those illustrated in FIG. 3, 3a, 3b, 3c, 6, 6a, 6b, 6c, 9, or 9a. For example, the visual indicia can be representative of the game animal represented by the decoy 1000, such as color or colors, pattern, outline, or other visually perceptible visual indicia typically found on the game animal represented by the decoy 1000. A representation of the game animal which the decoy 1000 represents is not required in all examples though; the first and second visual indicia 1022, 1024 need only be visually distinct from each other.

In operation, the motor 1006 draws power from the power supply. The motor 1006 then rotates the detachable moveable member 1004 from the first position to the second position. The motor 1006 can then rotate the detachable moveable member 1004 to move from the second position to the first position. The movement of the detachable moveable member 1004 can continue in this pattern until a user turns off the decoy 1000 by a switch, taking the batteries out, a remote control, or by any other means. The desired effect granted by the moving of the detachable moveable member 1004 is to display the different visual indicia at different times. The change in visual indicia that can be seen simulates the appearance and behavior of real animals. Thus, the simulation helps aid in the attraction of animals of that species, their predators, or other interesting animals.

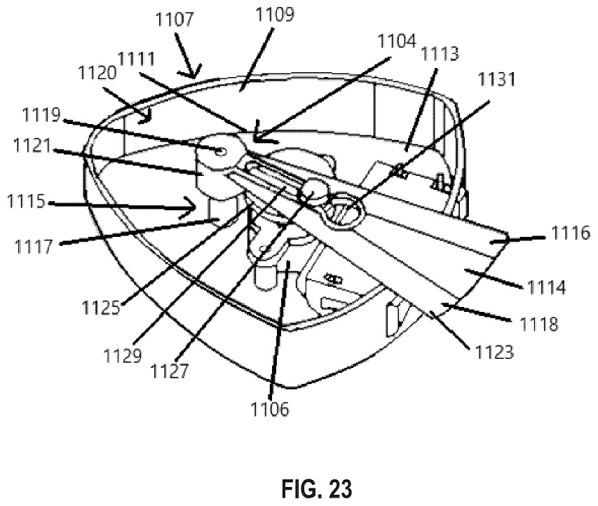

FIG. 23 illustrates a fourth example detachable moveable member 1104 disposed in a housing 1107, similar to that illustrated in FIG. 18. Although not illustrated, the housing 1107 and detachable moveable member 1104 can be attached and detached from any desired decoy, not illustrated. The housing 1107 includes a sidewall 1109 that extends along a perimeter 1111 of a base 1113 of the housing 1107, and a covering, not illustrated. The sidewall 1109 and the base defines a cavity 1120. The housing 1107 further includes a pin 1115 that has a pin first portion 1117 and a pin second portion 1119. The pin first portion 1117 has a larger diameter than the pin second portion 1119. The pin first portion 1117 is attached to the base 1113. The detachable moveable member 1104 has a detachable moveable member base 1121 and a detachable moveable member wedge 1123. The detachable moveable member base 1121 is disposed over the pin second portion 1119 and rests on the pin first portion 1117. The detachable moveable member base 1121 is rotatable relative to the pin second portion 1119. Although the movable member wedge 1123 is wedge shaped in the illustrated embodiment, any other desired shape mentioned in the above embodiments is acceptable. A motor 1106 is disposed between the base 1113 and the detachable moveable member 1104. The motor 1106 is in mechanical communication with a rotatable platform 1125 that has a protrusion 1127. The detachable moveable member wedge 1123 has a slit 1129 in which the protrusion 1127 is disposed through. The detachable moveable member 1104 is configured to oscillate as the rotatable platform 1125 rotates. The detachable movable member 1104 also includes an opening 1131 in which is configured to allow the detachable movable member 1104 to be separated from the motor 1106 and the housing 1107. The detachable moveable member 1104 also has a first region 1114, a second region 1116, and a third region 1118. The first region 1114 has a first visual indicia and the second region and third region have a second visual indicia that is different than the first visual indicia.

Those with ordinary skill in the art will appreciate that various modifications and alternatives for the described and illustrated examples can be developed in light of the overall teachings of the disclosure, and that the various elements and features of one example described and illustrated herein can be combined with various elements and features of another example without departing from the scope of the invention. Accordingly, the particular examples disclosed herein have been selected by the inventors simply to describe and illustrate examples of the invention and are not intended to limit the scope of the invention or its protection, which is to be given the full breadth of the appended claims and any and all equivalents thereof.

We claim:

1. A decoy, comprising:
a moveable member moveably affixed to a body where the moveable member is movable relative to the body between a first position and a second position; and
the moveable member having a first surface with a first region and a second region separate from the first region, the first region having a first visual indicia and the second region having a second visual indicia, the second visual indicia being different than the first visual indicia, the first visual indicia being at least partially within the body in the first position, the first visual indicia being partially outside the body in the second position.

2. The decoy of claim 1, wherein the moveable member is moveable from the first position to the second position by wind.

3. The decoy of claim 1, further comprising a motor connected to the moveable member, the motor adapted to move the moveable member from the first position to the second position.

4. The decoy of claim 1, wherein the moveable member has a third region and a third visual indicia.

5. The decoy of claim 4, wherein the moveable member has a fourth region and a fourth visual indicia.

6. The decoy of claim 1, wherein the first visual indicia is a pattern.

7. The decoy of claim 6, wherein the pattern includes a pattern of black and white.

8. The decoy of claim 1, wherein the decoy is the shape of a duck.

9. The decoy of claim 1, wherein the moveable member is adapted to oscillate between a first position and a second position.

10. The decoy of claim 1, wherein the moveable member is a disk.

11. The decoy of claim 10, wherein the disk is adapted to rotate about an axis.

12. The decoy of claim 5, wherein the first indicia and the second indicia are the same and the third indicia is different.

13. The decoy of claim 12, wherein the third indicia is the same as the fourth indicia.

14. The decoy of claim 1, wherein the moveable member is partially disposed in the body.

15. The decoy of claim 1, further comprising a material having a clear portion and a blacked-out portion disposed over the moveable member.

16. The decoy of claim 3, further comprising a weight that is attached to the moveable member and is adapted to oscillate the decoy.

17. The decoy of claim 3, wherein the motor is powered by a solar panel.

18. The decoy of claim 3, wherein the motor is powered by batteries.

19. A duck decoy comprising:
A body having a head portion connected to a body portion that is connected to a tail portion;
A moveable disk moveably affixed and at least partially disposed in the tail portion of the body, the moveable disk moveable relative to the body between a first position and a second position, the moveable disk having a first surface with a first region and a second region separate from the first region, the first region having a first visual indicia, the second region having a second visual indicia, the first visual indicia being different than the second visual indicia, the first visual indicia is at least partially within the body in the first position, and the first visual indicia is partially outside the body in the second position; and
a motor connected to the moveable disk, the motor being adapted to move the moveable disk from the first position to the second position.

20. A duck decoy system comprising:
a remote control in operative communication with a motor;
a body having a head portion connected to a body portion that is connected to a tail portion;
a moveable member moveably affixed and at least partially disposed in the tail portion of the body, the moveable member moveable relative to the body between a first position and a second position, the moveable member having a first surface with first region and a second region separate from the first region, the first region having a first visual indicia, the second region having a second visual indicia, the first visual indicia being different than the second visual indicia, the first visual indicia is at least partially within the body in the first position, and the first visual indicia is partially outside the body in the second position; and
the motor connected to the moveable member, the motor being adapted to move the moveable member from the first position to the second position.
